(19) United States
(12) Patent Application Publication
(10) Pub. No.: US 2013/0346735 A1
(43) Pub. Date: Dec. 26, 2013

(54) ENHANCED SYSTEM MANAGEMENT BUS

(71) Applicants: David M. Lynch, Dripping Springs, TX (US); Oswin E. Housty, Austin, TX (US)

(72) Inventors: David M. Lynch, Dripping Springs, TX (US); Oswin E. Housty, Austin, TX (US)

(73) Assignee: ATI Technologies ULC, Markham (CA)

(21) Appl. No.: 13/529,667

(22) Filed: Jun. 21, 2012

(51) Int. Cl. G06F 13/36; G06F 9/00

(52) U.S. Cl. 713/2; 710/100

(57) ABSTRACT

A method and device are provided for retrieving system data needed for boot up and/or wake-up. A bus hub is provided that retrieves needed data prior to such data being requested by the processor. The bus hub then stores the data. When a request is received for the data from the processor, the bus hub responds by sending the stored data.

### FIELD OF THE DISCLOSURE

The present disclosure is related to methods and devices related to serial bus devices. More specifically, the present disclosure is directed to methods and devices providing for a serial bus controller that is able to interact with serial bus devices in parallel with a processor that is executing other operations.

### BACKGROUND

Integrated circuits (ICs) are more expensive when they have more pins. To reduce the number of pins in an IC package, many ICs use a serial bus to transfer data. Some examples of such low-cost serial buses include SPI, I²C, UNI/O, and 1-Wire. The serial nature of the serial bus dictates that each device is queried in turn sequentially. During device startup or wake-up, there are a number of operations that need to be performed to boot up or wake up the device. This boot-up or wake-up process often includes checking the status (including existence) of various attached devices and writing to those devices.

Current System Management Bus configuration relies on a single controller in the southbridge to query every device in the system when the system BIOS requests information from those devices.

A subsequent device is not queried until the query of the previous device is completed. Similarly, instructions that need to be written out to devices from the CPU are done in a serial manner. Additionally, various devices sit idle during portions of startup as the CPU performs other operations. Both the idle time of the devices and the serial progression through the devices (querying and writing) incur a time cost that delays completion of a boot up sequence for a computing device. Clearly, the more devices in a given system, the larger boot time delay imposed thereby. Large server systems with multiple CPU's can have a larger number of DIMMs, for example 64 DIMMs or more, as well as additional devices to be queried. The time it takes to read all of those devices may cause an operator to think that the system is not booting up because there can be no display until after memory is initialized.

Accordingly, there exists a need for an improved method and apparatus that reduces the time incurred by serial progression through the devices.

There further exists a need for such improved method and apparatus that is compatible with existing serial architecture.

### BRIEF DESCRIPTION OF THE DRAWINGS

FIG. 1a is a diagram showing existing computing architecture;

FIG. 1b is a communication chart showing exemplary communications implemented on the architecture of FIG. 1a;

FIG. 2a is a diagram showing computing architecture employing a “Super Hub” of the present disclosure;

FIG. 2b is a communication chart showing exemplary communications implemented on the architecture of FIG. 2a;

FIG. 3a is a diagram showing another embodiment of computing architecture of the present disclosure;

FIG. 3b is a communication chart showing a first embodiment of communications implemented on the architecture of FIG. 3a;

FIG. 3c is a communication chart showing a second embodiment of communications implemented on the architecture of FIG. 3a;

FIG. 3d is a communication chart showing a third embodiment of communications implemented on the architecture of FIG. 3a;

FIG. 4 is a diagram showing another embodiment of computing architecture of the present disclosure;

FIG. 5 is a communication chart showing a first embodiment of write communications implemented on the architecture of either FIG. 2a or FIG. 3a; and

FIG. 6 is a communication chart showing a second embodiment of write communications implemented on the architecture of either FIG. 2a or FIG. 3a.

### DETAILED DESCRIPTION

In an exemplary and non-limited embodiment, aspects of the invention are embodied in a method and device for retrieving system data needed for boot up and/or wake-up. A bus hub is provided that retrieves needed data prior to such data being requested by the processor. The bus hub then stores the data. When a request is received for the data from the processor, the bus hub responds by sending the stored data.

Briefly, in one example, a method of providing information about at least one device to a processor is provided including storing a first piece of information about a first device at a bus hub; receiving a request from the processor for the first piece of information stored at the bus hub; and responding to the request by sending the stored first piece of information to the processor.

In another example, a method of enacting settings for at least one circuit device is provided including receiving first settings for a first device from a processor; storing the first settings at a bus hub; and issuing one or more instructions to the first device, the instructions, when received by the first device, enacting the first settings.

In yet another example, a bus hub is provided including a first input/output port operable to perform one or more of receiving queries from, receiving instructions from, and providing information to a processor; a second input/output port operable to perform one or more of sending queries to, sending instructions to, and receiving information from a system component; and a memory operable to perform one or more of storing information received from the system component and storing instructions received from the processor.

In still another example, a method of performing boot-up and/or wake-up is provided including: retrieving system information needed by a processor for boot-up/wake-up prior to such information being requested by the processor; storing the system information in a location accessible to the processor; receiving a request from the processor for the stored system information; and providing the stored system information to the processor.

In another example, a computer readable medium is provided containing non-transitory instructions thereon, that when interpreted by at least one processor cause the at least one processor to: request first information; and receive the first information from a bus hub, the bus hub having obtained and stored the first information prior to issuance of the request for the first information.

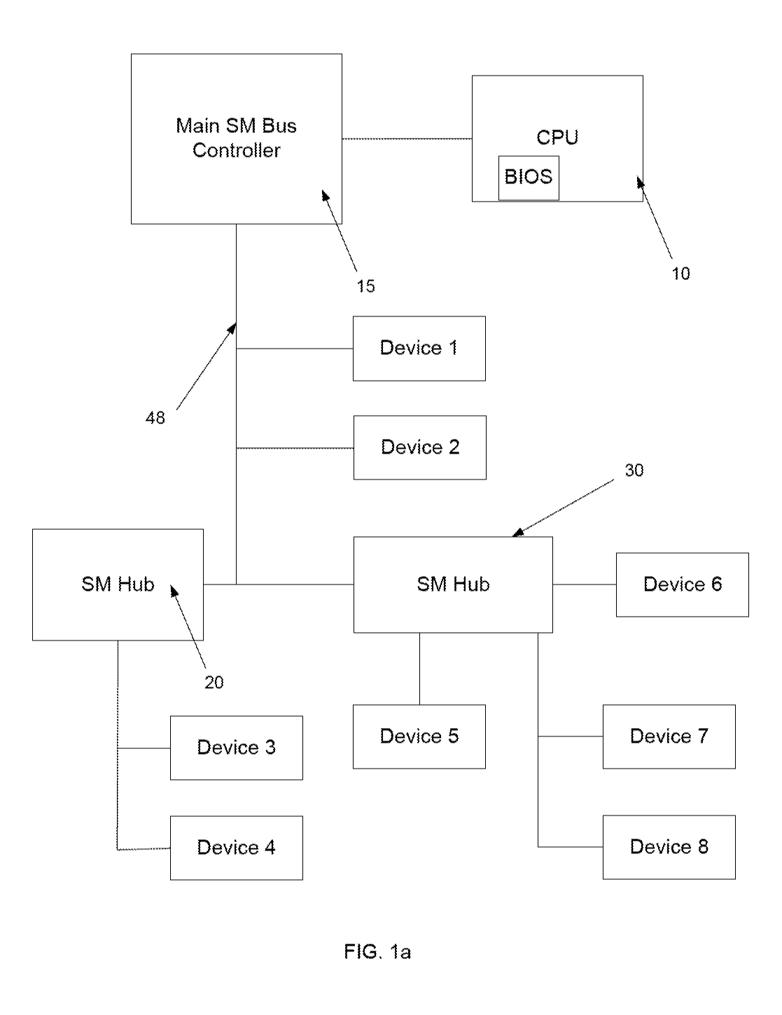

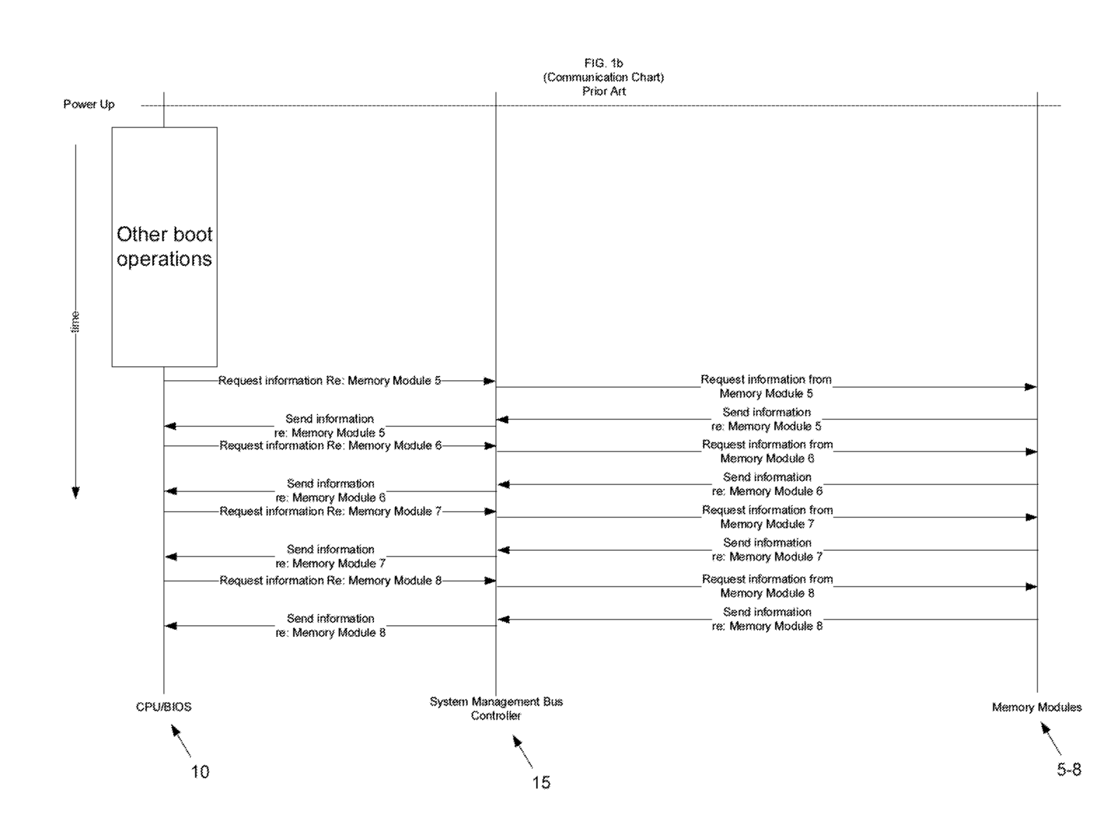

FIGS. 1a&b are a diagram and communications chart, respectively, showing how the prior art handles devices. In sum, on power-up (or wake-up from a sleep mode or other reduced power setting) as part of a power-on self-test or otherwise—i.e., transition to an operational state from a non-operational state (that latter including a reduced operational state), CPU 10 and BIOS send out queries for attached devices 1, 2, 3, 4, 5, 6, 7, 8, etc. to determine what devices are connected to CPU 10. In one example, the queried devices 1, 2, 3, 4, 5, 6, 7, 8 are memory devices that utilize the Serial Presence Detect (SPD) standard. Herein, devices 1, 2, 3, 4, 5, 6, 7, 8 will be discussed as memory devices. However, it should be appreciated that the concepts discussed herein can be used for any System Management Bus compatible devices, including but not limited to those employing I²C (such as game consoles, PC's, servers, and mobile devices). Other non-limiting examples of suitable devices include a laptop's rechargeable battery subsystem, temperature sensors, fan sensors, voltage sensors, lid switches and clock chips.

As shown in FIG. 1b, there is a span of time in which CPU 10 is conducting boot operations and one or more hubs 20, 30 and memory modules 1, 2, 3, 4, 5, 6, 7, 8 are not being actively employed. FIG. 1b specifically shows interaction with memory modules 5-8. Accordingly, in one example, the “other boot operations” could be interaction with memory modules 1-4. Regardless, memory modules 5-8 (and associated hub 30) are idle until CPU 10 proceeds through its operations order and arrives at the time when memory module 5 is to be queried. Various requests and responses are then sent out and received by CPU 10, relayed via System Management Bus Controller (SM Bus Controller) 15, to and from memory modules 5-8. Overall, memory modules 5-8 are not active until CPU 10 requests for them to be active.

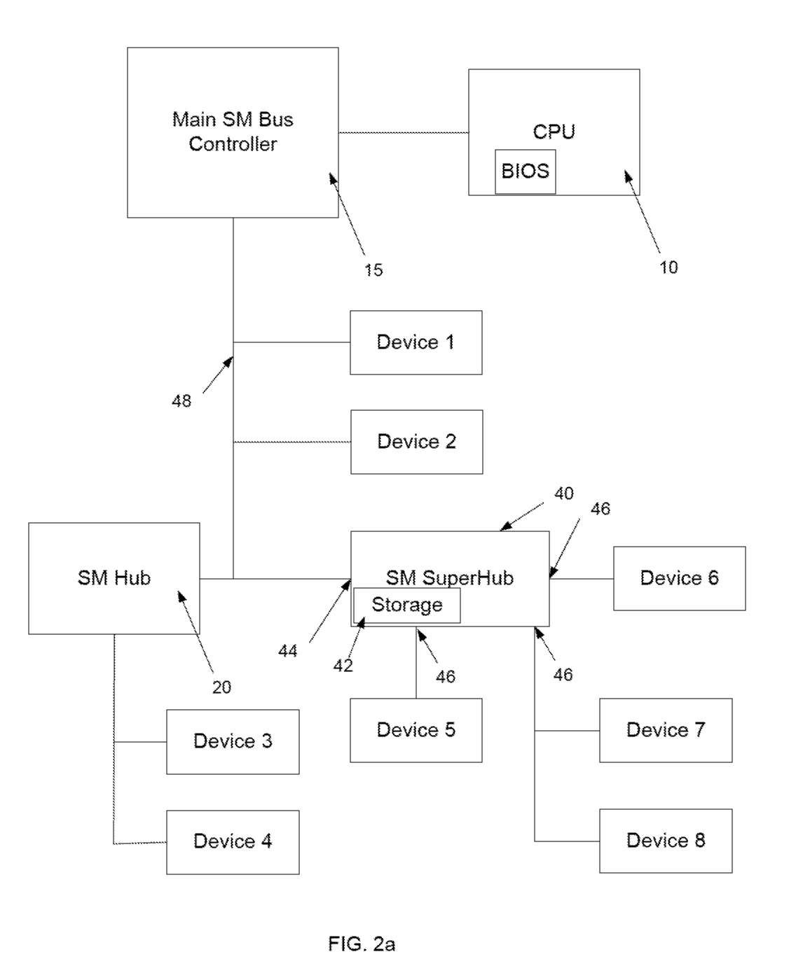

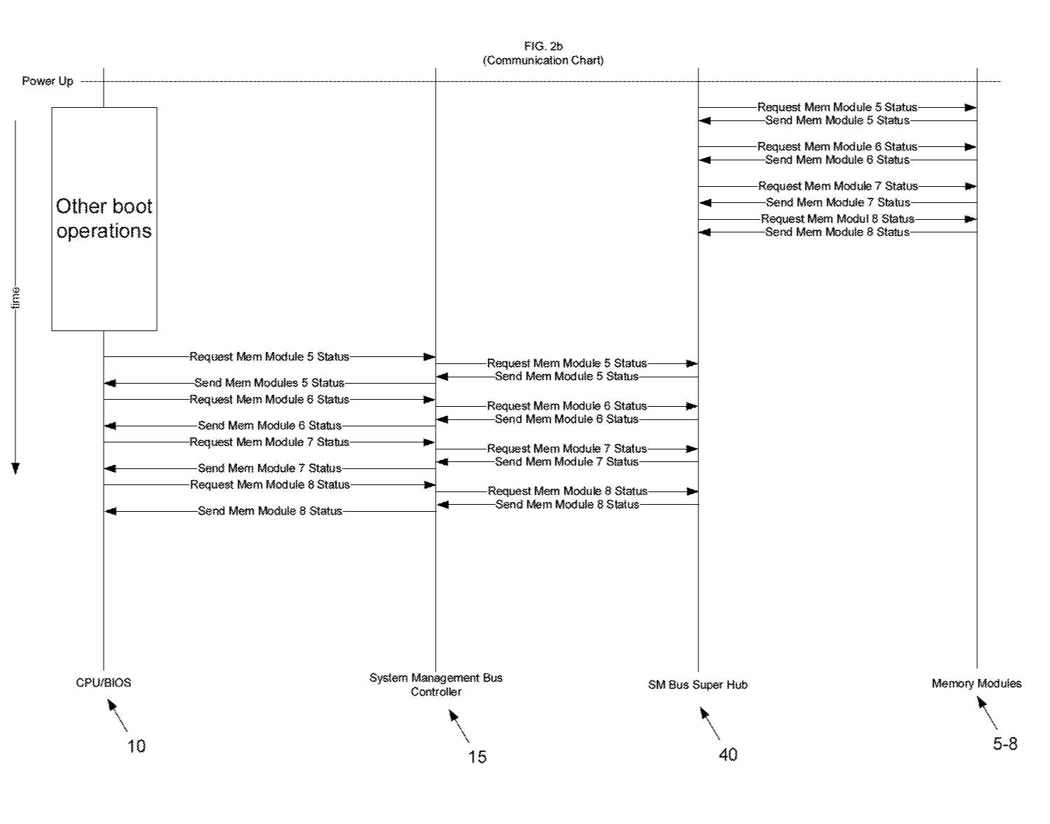

Turning now to FIG. 2a, a System Management Super Hub (SM Super Hub) 40 is shown. SM Super Hub 40 includes internal memory/storage 42 and a plurality of input/output ports/interfaces 44, 46. Storage 42 stores instructions for SM Super Hub 40 and stores information for and/or from memory modules 5-8.

As shown in FIG. 2b, at power-up, SM Super Hub 40 does not wait for a query from CPU 10 to engage memory modules 5-8. At power-up SM Super Hub 40 begins to query memory modules 5-8. In the provided example, the query is an SPD query. SM Super Hub 40 then stores the responses from memory modules 5-8 in storage 42. The querying of memory modules 5-8 is being done at the same time as CPU 10 is performing other boot operations. At the point when CPU 10 sends out a query for memory module 5, the response data is already present at storage 42 of SM Super Hub 40. SM Super Hub 40 thus responds to the query without having to query memory module 5 in between query from and response to CPU 10. Subsequent queries received by SM Super Hub 40 relating to memory modules 6-8 are similarly responded to. Additionally, it should be appreciated that while the provided architecture allows information about memory modules 5-8 to be located closer to CPU 10, embodiments are also envisioned where the communications bus between Main SM Bus Controller (and/or CPU 10) is faster than the communication link between SM Super Hub 40 and memory modules 5-8. In such an embodiment, the information regarding the status of memory modules 5-8 is stored at a location where the slowest communication link need not be used at the point in time that CPU 10 requests the information.

Additionally, it should be appreciated that the embodiment of FIG. 2a requires no changes to the BIOS or CPU 10. SM Super Hub 40 takes the place of traditional SM Hub 40 and is called via Main SM Bus Controller 15. The actions of SM Super Hub 40 are transparent to both CPU 10 and Main SM Bus Controller 15. All CPU 10 and Main SM Bus Controller 15 see is that they sent out a request and the desired information was returned.

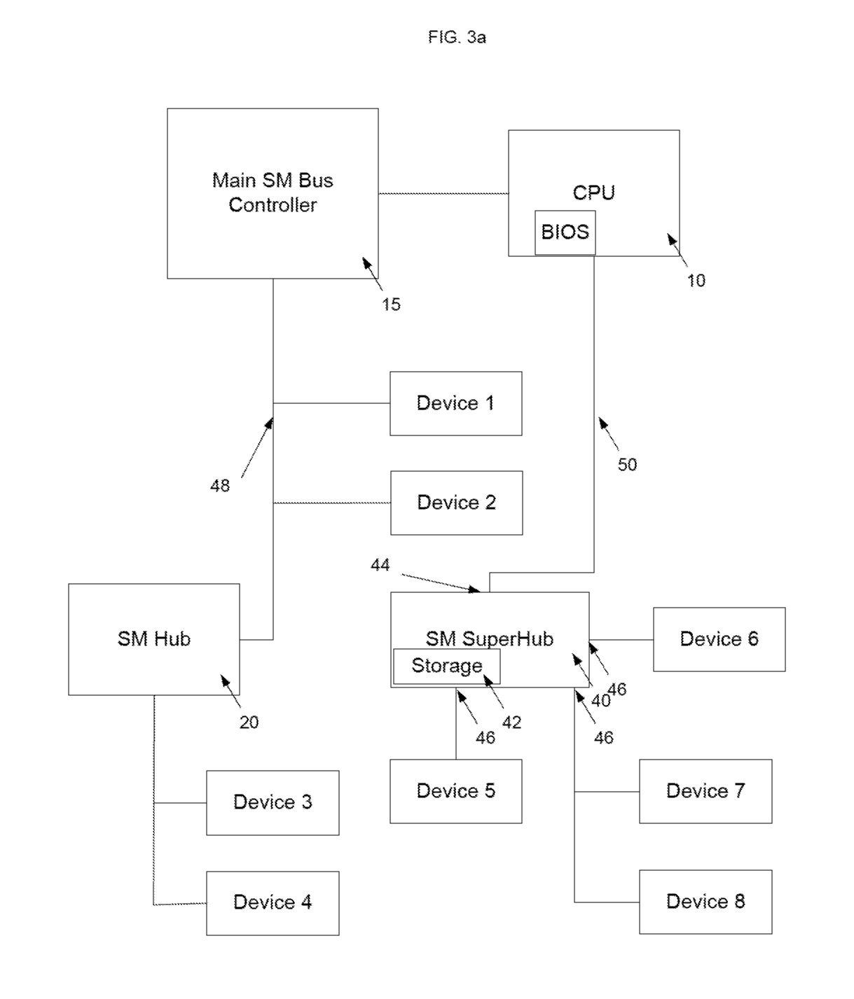

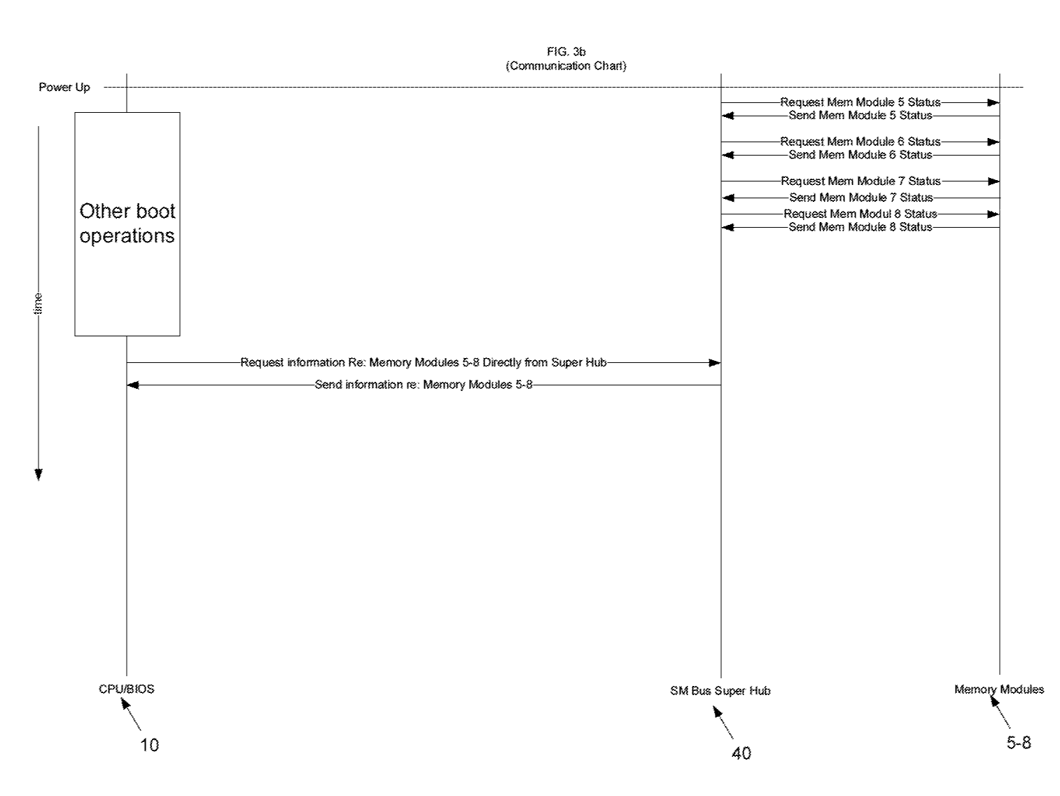

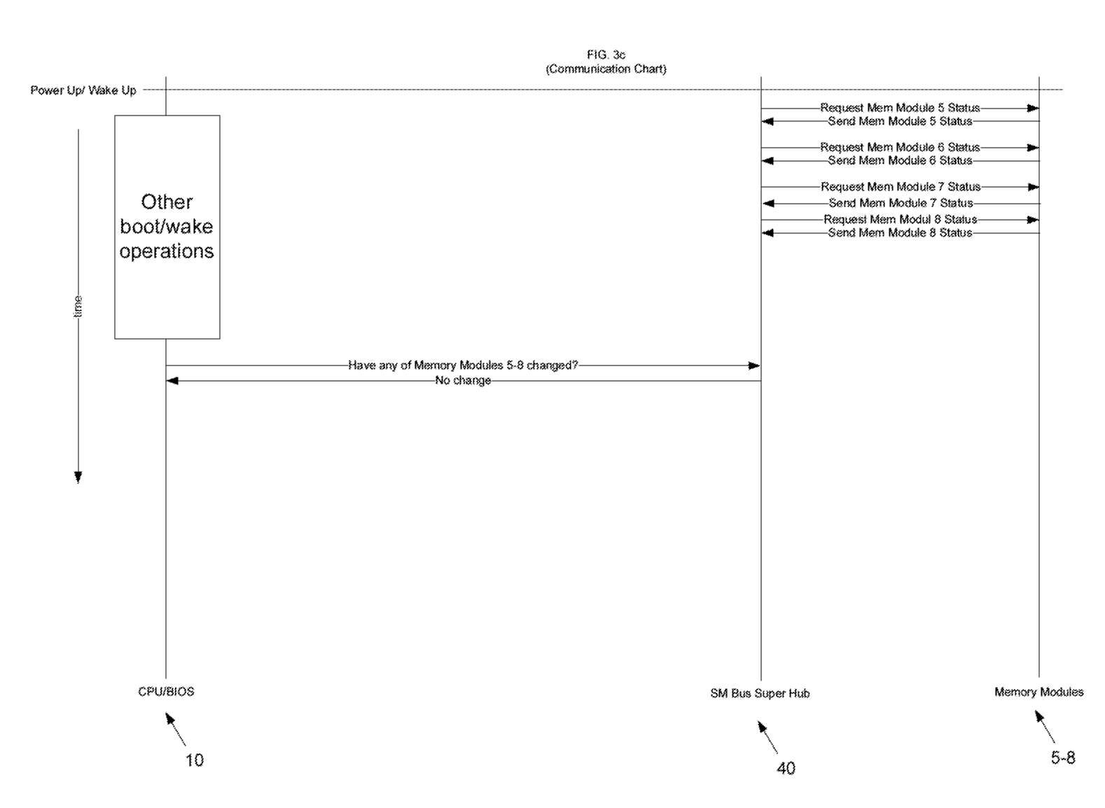

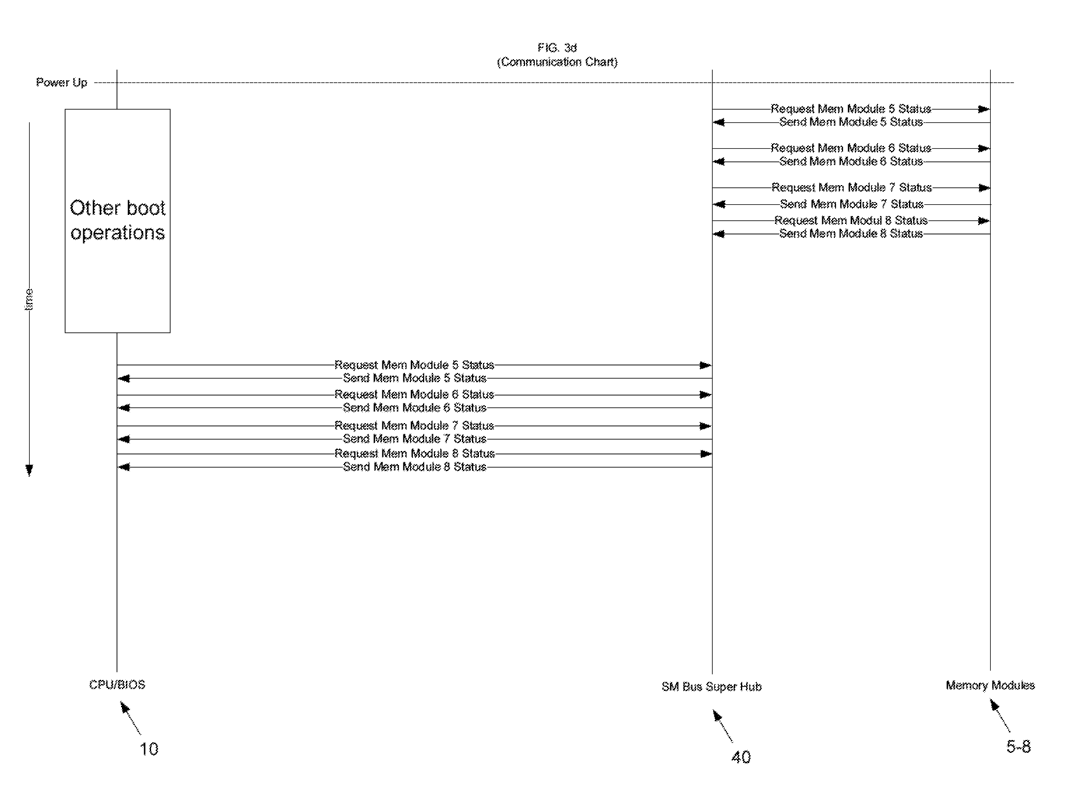

FIG. 3a shows an embodiment where a separate bus 50 is supplied that directly connects CPU 10 to SM Super Hub 40. In the provided embodiment, bus 50 is a high speed bus that is faster than bus 48 between Main SM Bus Controller 15 and SM Hub 20.

FIG. 3d shows a communication chart for the hardware of FIG. 3a that is similar to the communication chart of FIG. 2b. It should be appreciated that relative to the hardware of FIG. 2a, the embodiment of FIG. 3a requires use of an extra pin at CPU 10 and requires a BIOS change to direct relevant queries and instructions (queries and instructions for memory modules 5-8) to the pin connected to SM Super Hub 40.

As previously noted, at power-up, SM Super Hub 40 does not wait for a query from CPU 10 to engage memory modules 5-8. At power-up SM Super Hub 40 begins to query memory modules 5-8. SM Super Hub 40 then stores the responses from memory modules 5-8 in storage 42. The querying of memory modules 5-8 is being done at the same time as CPU 10 is performing other boot operations. At the point when CPU 10 sends out a query for memory module 5, the response data is already present at storage 42 of SM Super Hub 40. Additionally, the query is sent directly to SM Super Hub 40 rather than being routed through SM bus Controller 15. SM Super Hub 40 thus responds to the query without having to query memory module 5 in between query from and response to CPU 10. Subsequent queries received by SM Super Hub 40 relating to memory modules 6-8 are similarly responded to.

FIG. 3b shows a communication chart for the hardware of FIG. 3a where the hardware is programmed to be able to take advantage of compression of the data. As in other provided examples, at power-up, SM Super Hub 40 does not wait for a query from CPU 10 to engage memory modules 5-8. At power-up SM Super Hub 40 begins to query memory modules 5-8. SM Super Hub 40 then stores the responses from memory modules 5-8 in storage 42. The querying of memory modules 5-8 is being done at the same time as CPU 10 is performing other boot operations. SM Super Hub 40 then compresses the responses for memory modules 5-8 into a single message. SM Super Hub 40 then stores this compressed message. The BIOS at CPU 10 is programmed to request and be able to parse compressed responses from SM Super Hub 40. At the point when CPU 10 sends out a query for memory modules 5-8, the response data is already present at storage 42 of SM Super Hub 40. SM Super Hub 40 thus responds to the query without having to query memory modules 5-8 in between query from and response to CPU 10. Additionally, after receiving the single response for modules 5-8, CPU 10 can be interpreting the information about modules 5-8 while it is querying other devices via bus 48.

It should be appreciated that the compression techniques shown in FIG. 3b can also be employed with the hardware of FIG. 2a with respect to memory modules 5-8. In such an embodiment the BIOS would need to be updated to know to request and receive compressed data. Again, after receiving the single response for modules 5-8, CPU 10 can be interpreting the information about modules 5-8 while it is querying other devices.

FIG. 3c shows another embodiment communication chart that while discussed with reference to the hardware of FIG. 3a can also be employed by the hardware of FIG. 2a with respect to memory modules 5-8. The embodiment of FIG. 3c requires that one or more of the components (CPU 10, MS Super Hub 40) have memory that can store the status of the Memory Modules 5-8 between sessions. For the example where sessions are distinct boot-ups where power is removed from the circuit therebetween, such memory would be non-volatile memory. For examples where sessions are sessions before and after a “sleep mode” or another limited functionality mode where power is maintained in at least some nominal manner to the circuit, both volatile and non-volatile memory may suffice.

Memory at CPU 10 stores state information for memory modules 5-8. Upon power-up or wake-up, SM Super Hub 40 queries modules 5-8 in the manner discussed above. SM Super Hub 40, via storage 42, also has an indication of the previous status reported to CPU 10. SM Super Hub 40 then compares the newly obtained state information for modules 5-8 with the previously reported state information.

At the point in the startup sequence where memory modules 5-8 are to be checked, CPU 10 issues a query to SM Super Hub 40 asking if there has been any change to the status of modules 5-8. If there has been no change, then SM Super Hub 40 can respond with that fact. CPU 10 then knows that it can use the values stored at CPU 10. If there has been a change, then SM Super Hub 40 replies by sending a compressed response that provides the status of each of modules 5-8. In this way, the query sent by CPU 10 is similar to a “Conditional Get” HTTP command with an implied “If modified since—last report” reference point. This construct both economizes the amount of data sent if there is no change and economizes on the data that is sent and how soon it is sent if there is a change to modules 5-8.

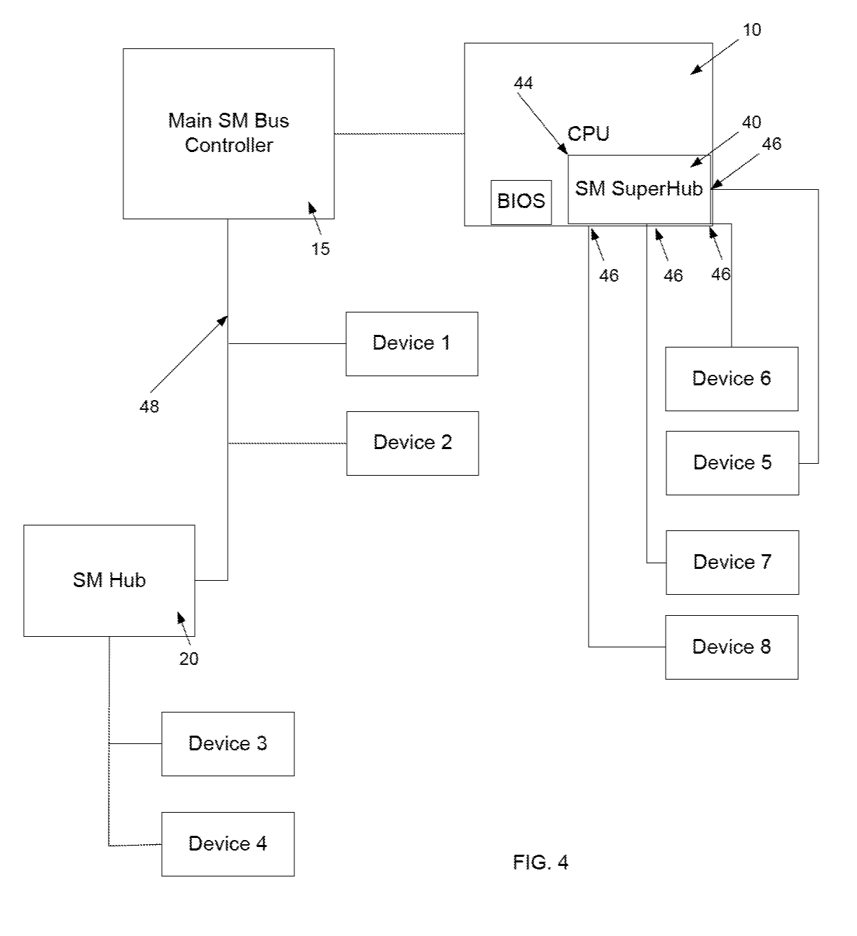

FIG. 4 shows an embodiment where SM Super Hub 40 is integrated into CPU 10. At power-up, SM Super Hub 40 does not wait for a query from CPU 10 to engage memory modules 5-8. At power-up SM Super Hub 40 begins to query memory modules 5-8. In the embodiment of FIG. 4, each of memory modules 5-8 is allocated its own pin on CPU 10. SM Super Hub 40 stores the responses from memory modules 5-8. The querying of memory modules 5-8 is being done at the same time as CPU 10 is performing other boot operations and checking other modules via Main SM Bus Controller 15. At the point when CPU 10 wishes to query memory modules 5-8, the response data is already present at SM Super Hub 40. SM Super Hub 40 thus responds to the query without having to query memory modules 5-8.

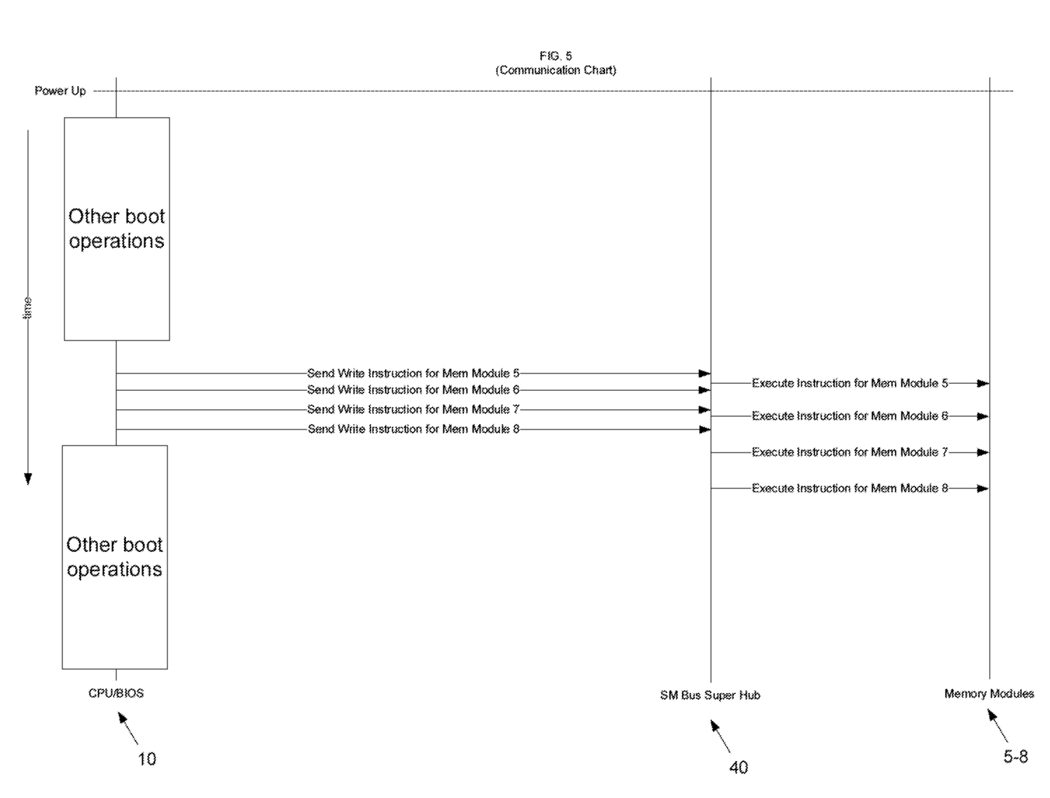

To this point, SM Super Bus 40 has been discussed as a device that queries devices 5-8 and reports back to CPU 10 to allow a serial bus architecture to achieve efficiencies more closely approximating parallel processing buses. The described architecture can also be utilized to distribute commands and writes from CPU. As shown in FIG. 5, write instructions are sent from CPU 10 to SM Super Hub 40. SM Super Hub 40 can store the sent instructions in storage 42 and then execute them. CPU 10 is thereby relieved from having to wait any amount of time that is needed to transmit the write instructions all the way to modules 5-8 and any time that is necessary to actually write and implement the instructions at modules 5-8.

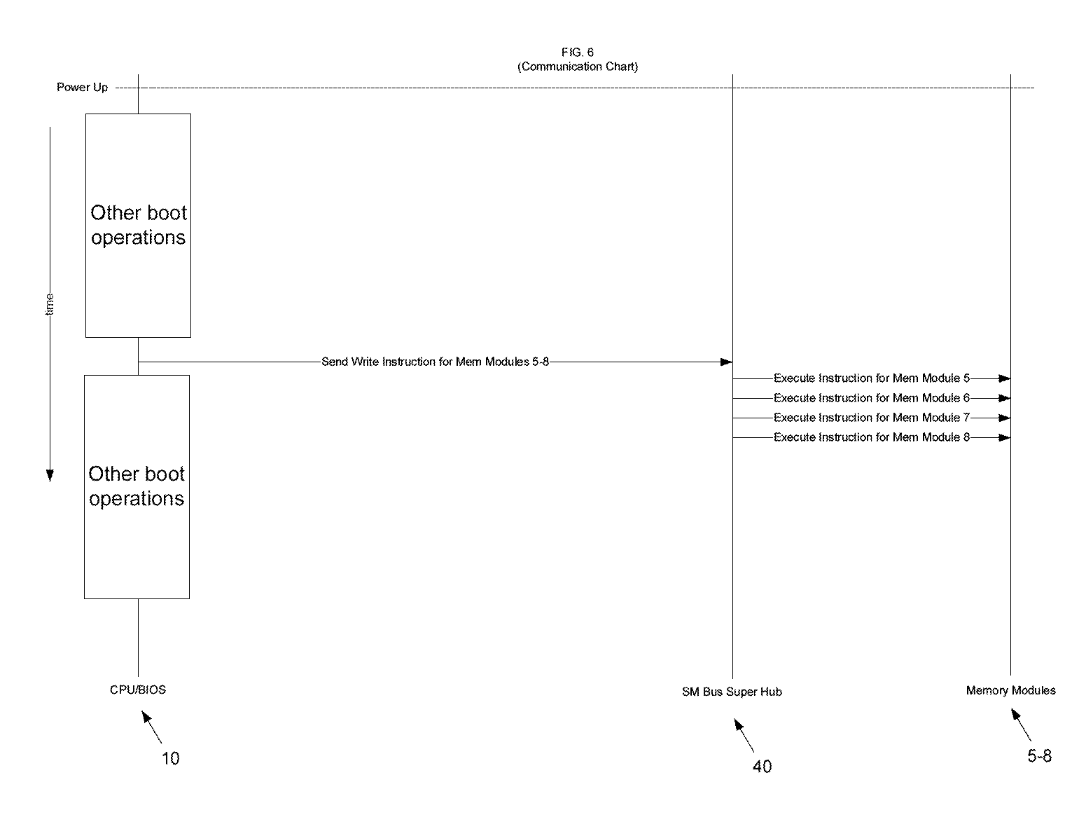

Additional examples of the write functionality are shown in FIG. 6. The communication chart of FIG. 6 describes two different embodiments. The first embodiment shown by FIG. 6 is where each of modules 5-8 has a discrete instruction from CPU 10. CPU 10 compresses the instructions and sends a single message to SM Super Hub 40. SM Super Hub 40 then decompresses the message and then communicates and implements each discrete instruction at its intended module 5-8. CPU 10 is able to continue on with its boot process while SM Super Hub 40 is decompressing and implementing the instructions.

FIG. 6 also describes an embodiment where CPU 10 wishes to implement common setting for multiple modules 5-8. Accordingly, CPU 10 sends the instruction to SM Super Hub 40 to implement the setting on modules 5-8. CPU 10 then moves on with other actions while SM Super Hub 40 issues the write setting to each of modules 5-8. Thus, this functionality, from the perspective of CPU 10, implements the ability to issue a setting “broadcast” as opposed to discrete instructions to multiple modules 5-8.

The above detailed description and the examples described therein have been presented for the purposes of illustration and description only and not for limitation. For example, the operations described may be done in any suitable manner. The method may be done in any suitable order still providing the described operation and results. It is therefore contemplated that the present embodiments cover any and all modifications, variations or equivalents that fall within the spirit and scope of the basic underlying principles disclosed above and claimed herein. Furthermore, while the above description describes hardware in the form of a processor executing code, hardware in the form of a state machine, or dedicated logic capable of producing the same effect are also contemplated.

The software operations described herein can be implemented in hardware such as discrete logic fixed function circuits including but not limited to state machines, field programmable gate arrays, application specific circuits or other suitable hardware. The hardware may be represented in executable code stored in non-transitory memory such as RAM, ROM or other suitable memory in hardware descriptor languages such as but not limited to RTL and VHDL or any other suitable format. The executable code when executed may cause an integrated fabrication system to fabricate an IC with the operations described herein

Also, integrated circuit design systems/integrated fabrication systems (e.g., work stations including, as known in the art, one or more processors, associated memory in communication via one or more buses or other suitable interconnect and other known peripherals) are known that create wafers with integrated circuits based on executable instructions stored on a computer readable medium such as but not limited to CDROM, RAM, other forms of ROM, hard drives, distributed memory, etc. The instructions may be represented by any suitable language such as but not limited to hardware descriptor language (HDL), Verilog or other suitable language. As such, the logic, software, and circuits described herein may also be produced as integrated circuits by such systems using the computer readable medium with instructions stored therein. For example, an integrated circuit with the aforedescribed software, logic, and structure may be created using such integrated circuit fabrication systems. In such a system, the computer readable medium stores instructions executable by one or more integrated circuit design systems that causes the one or more integrated circuit design systems to produce an integrated circuit.

What is claimed is:

1. A method of providing information about at least one device to a processor including:
storing a first piece of information about a first device at a bus hub;
receiving a request from the processor for the first piece of information stored at the bus hub; and
responding to the request by sending the stored first piece of information to the processor.

2. The method of claim 1, further including
querying a first device for a first piece of information about the first device; and
receiving a response from the first device providing the first piece of information;

3. The method of claim 2, further including:
querying a second device for a second piece of information about the second device;
receiving a response from the second device providing the second piece of information; and
storing the second piece of information at the bus hub.

4. The method of claim 3, wherein the request from the processor for the first piece of information is a single request requesting the first and second pieces of information.

5. The method of claim 4, wherein responding to the request by sending the stored first piece of information includes sending the second piece of information in a single transmission with the first piece of information.

6. The method of claim 4, wherein responding to the request by sending a single transmission with the first and second pieces of information provides a compressed transmission to the processor containing both the first and second pieces of information.

7. The method of claim 2, wherein the querying occurs without prompting directly or indirectly from the processor.

8. The method of claim 2, wherein the querying occurs in response to a change in power status of a circuit containing the first device.

9. The method of claim 2, wherein the querying takes place concurrently with the processor performing other tasks.

10. The method of claim 2, wherein the querying is part of one of a boot up and a wake up set of operations and wherein the querying occurs while the processor is performing other boot up/wake up operations.

11. The method of claim 10, wherein the querying is part of a power-on self-test.

12. The method of claim 2, wherein the querying occurs during one of a boot up process and a wake up process.

13. The method of claim 1, further including receiving an indication that a circuit containing the first device has entered a changed power mode.

14. The method of claim 1, wherein the first piece of information is an indication of whether a status of a first device has changed since a previous point that the status of the first device was reported to the processor.

15. The method of claim 1, wherein the first device is a memory module and the first piece of information is serial presence detect information.

16. A method of enacting settings for at least one circuit device including:
receiving first settings for a first device from a processor;
storing the first settings at a bus hub; and
issuing one or more instructions to the first device, the instructions, when received by the first device, enacting the first settings.

17. The method of claim 16, wherein the issuing occurs concurrently with the processor performing other boot-up or wake-up operations.

18. The method of claim 16, wherein issuing is performed by the bus hub.

19. The method of claim 16, wherein the first settings for at least one circuit device are received concurrently with second settings for a second circuit device.

20. The method of claim 19, wherein the first settings for the first device are the same as the second settings for the second device.

21. The method of claim 19, wherein the first settings for the first device are different from the second settings for the second device.

22. The method of claim 19, wherein the first and second settings are received in a compressed format.

23. The method of claim 16, wherein the issuing is part of one of a boot up and a wake up set of operations and wherein the issuing occurs while the processor is performing other boot up/wake up operations.

24. A bus hub including:
a first input/output port operable to perform one or more of receiving queries from, receiving instructions from, and providing information to a processor;
a second input/output port operable to perform one or more of sending queries to, sending instructions to, and receiving information from a system component; and
a memory operable to perform one or more of storing information received from the system component and storing instructions received from the processor.

25. The bus hub of claim 24 further including a bus coupled to the first input/output port and operable to allow the bus hub to directly communicate with the processor.

26. The bus hub of claim 24, wherein the first input/output port is operable to receive an indication of a change in power mode of a system.

27. The bus hub of claim 24, further including instructions stored on the memory, that when interpreted cause multiple pieces of information to be compressed into a single message and cause a compressed set of instructions to be decompressed into multiple instructions.

28. A method of performing boot-up and/or wake-up including:
retrieving system information needed by a processor for boot-up/wake-up prior to such information being requested by the processor;
storing the system information in a location accessible to the processor; and
providing the stored system information to the processor.

29. The method of claim 28, wherein retrieving system information includes querying devices coupled to and/or controllable by the processor.

30. The method of claim 28, wherein the information needed by the processor includes Serial Presence Detect information for multiple attached devices.

31. The method of claim 30, wherein providing the stored system information to the processor includes sending compressed information containing Serial Presence Detect information for at least two devices.

32. The method of claim 28, further including receiving an indication that boot-up and/or wake-up has been initiated.

33. The method of claim 28, further including receiving a request from the processor for the stored system information.

34. A computer readable medium containing non-transitory instructions thereon, that when interpreted by at least one processor cause the at least one processor to:
request first information; and
receive the first information from a bus hub, the bus hub having obtained and stored the first information prior to issuance of the request for the first information.

35. The computer readable medium of claim 34, wherein the instructions are embodied in hardware description language suitable for one or more of describing, designing, organizing, fabricating, or verifying hardware.
